(19) United States
(12) Patent Application Publication
(10) Pub. No.: US 2025/0359670 A1
(43) Pub. Date: Nov. 27, 2025

(54) COMPONENT FOR SHELF UNITS, SHELVES, BOOKCASES, STAIRS AND SIMILAR FURNISHING ELEMENTS AND ITS MANUFACTURING PROCESS

(71) Applicant: LUCE5 S.R.L., Montevarchi (IT)

(72) Inventor: Stefano CETOLONI, Montevarchi (IT)

(21) Appl. No.: 18/864,939

(22) PCT Filed: May 12, 2023
(86) PCT No.: PCT/IB2023/054923

§ 371 Date: Nov. 12, 2024

(30) Foreign Application Priority Data
May 12, 2022 (IT) 102022000009845

(51) Int. Cl. A47B 96/02; A47B 65/00; A47B 96/20; B32B 3/12; B32B 3/30; B32B 7/08; E04F 11/02

(52) U.S. Cl. CPC A47B 96/021; A47B 65/00; A47B 96/206; B32B 3/12; B32B 3/30; B32B 7/08; E04F 11/02; A47B 2220/0077; B32B 2479/00; E04F 2011/0203; E04F 2290/026

(57) ABSTRACT

Described is a component (1) for shelving, shelves, bookcases, stairs and similar furnishing elements which comprises at least two laminar elements (2′, 2″) substantially parallel to each other and which define a plane (P) of extension of the component (1).

These laminar elements (2′, 2″) are for covering an intermediate layer (3), interposed between them, substantially coplanar to the plane (P). The intermediate layer (3) has a frame consisting of metal crosspieces (3′, 3″) connected to each other by snap fitting means (32, 33). The frame is for supporting at least one elongate element (4), made of metal material, extending along a longitudinal direction (X) substantially normal relative to the plane (P) and in which they house induction lighting means (6). The elongate element (4) is positioned inside the perimeter defined by said frame. The metal crosspieces (3′, 3″) have ducts (31) for the passage of cables (7) for electrifying the lighting means (6).

### TECHNICAL FIELD

This invention relates to a furnishing component for shelving, shelves, bookcases, stairs and similar furnishing elements and its production process.

### BACKGROUND ART

The need is increasingly felt, by designers and architects, to offer original shapes and new functionalities of the furnishing, both to make the environment more comfortable for those who work or live there, and to make it exclusive.

It is now customary to make, or seek to construct, a type of furnishing which can be both an expression of technology, but also of formal rigour: two requirements which are difficult to bring together in a single system.

Moreover, users are increasingly demanding original and personalised furniture, that is to say, “tailored” furniture.

Together with these aesthetic requirements, there is also the need to reduce the overall dimensions by creating cleaner lines, providing furnishings of reduced thicknesses.

Lastly, in order to reduce the costs it is now essential to render the product systematic, defining functional construction parameters which, in the practical execution of shelves of this type, start from basic extruded elements, which can be adapted and assembled to the required measurements.

### AIMS AND SUMMARY OF THE INVENTION

The aim of the invention is to provide a component for shelving, shelves, bookcases, stairs and similar furnishing elements which allows the problems linked to the prior art to be overcome and to satisfy the above-mentioned requirements.

In the context of the above-mentioned purpose, an aim of the invention is to provide a component for shelving, shelves, bookcases, stairs and similar furnishing elements which combines an advanced technology with strict aesthetic standards.

Another aim of the invention is to allow the creation of shelving, shelves, bookcases, stairs and other furnishing elements which are very customisable.

Another aim of the shelves according to the invention is to have extremely thin thicknesses, but aesthetically refined shapes.

Yet another aim of the invention is to provide a component for shelving, shelves, bookcases, stairs and similar furnishing elements with means which are easily available on the market and using materials of common use, in such a way that the device is economically competitive.

### BRIEF DESCRIPTION OF THE INVENTION

This purpose, as well as these and other aims, which are described in more detail below, are achieved by component for shelving, shelves, bookcases, stairs and similar furnishing elements according to the invention comprising the technical features described in one or more of the appended claims. The dependent claims correspond to possible different embodiments of the invention.

More specifically, according to a first aspect, the invention relates to a component for shelving, shelves, bookcases, stairs and similar furnishing elements, with a so-called “sandwich” structure wherein an intermediate layer is interposed between two layers substantially consisting of two laminar elements.

The intermediate layer has a frame composed of interconnected metal crosspieces, for example a pair of vertical and horizontal aluminium rods, mutually normal, preferably removable, by snap fitting means, preferably of the male-female type.

The frame is for supporting one or more elongate elements, also made of metal material, also preferably aluminium, for housing induction lighting means, for example LEDs, of per se known type, and positioned inside the perimeter defined by the frame.

The metal crosspieces have advantageously ducts for the passage of cables for electrifying the lighting means which, as well as allowing the completion of the lighting system in the component, provides the possibility of integrating inside panels, shelving, shelves, bookcases, stairs and the like, also additional functions, such as induction power supply systems, signal connection devices, etc.

Advantageously, the electrification cables have pressurise-fitted electrical contacts which allow the passage of current and the switching on of light without having to perform wiring. In this way, the lighting means are designed to be activated by the contact with a suitable switch positioned on an outer wall substantially normal relative to the plane of extension of the component.

This feature allows anyone to easily and insert and remove, without risk, the shelves from the sides of the furniture.

In practice, the product made in this way allows multiple developments in the integration of lighting and/or electronics components and allows compartments to be made for housing these components, making them basically “invisible”.

Advantageously, there is a reinforcement plate positioned inside the perimeter defined by the frame. The plate has a structure consisting of a tessellation of the space of the honeycomb type, preferably honeycomb-shaped, and is adjacent to the elongate element. This type of plate, which is only known in the aerospace sector, even though it is extremely light, gives excellent mechanical characteristics to the structure.

In particular, the honeycomb structure made of aluminium guarantees a mechanical strength such as to be able to reach greater lengths with smaller thicknesses and without the aid of intermediate supports.

Preferably, the elongate element extends along a longitudinal direction substantially normal relative to the plane of extension of the component.

Further, the elongate element comprises an inner groove for housing the lighting means. The inner groove extends along the above-mentioned longitudinal direction and has a substantially elliptical curvilinear profile, shaped in such a way that the light source of the lighting means is hidden from direct contact with the eye of the user.

In use, the light which escapes from the inner groove, formed entirely by a cutter, thanks precisely to the particular geometrical shape of the groove, means that the light source is hidden, preventing glare to the human eye.

Advantageously, the curved profile is made by placing in succession at least three circular arcs of different radius and in increasing sequence (a circumference of smaller radius, one of intermediate radius and a third of larger radius), so as to allow the head of the machining cutter to enter into the thickness to be removed in the most suitable manner.

Preferably, the larger of the three radiuses is greater than the intermediate radius by a percentage range of between 33 and 43%. inclusive, preferably between 35 and 41%, inclusive, more preferably between 37 and 39% inclusive, even more preferably substantially equal to 38%.

Similarly, the intermediate radius is in turn preferably larger than the smaller radius by a percentage range of between 60 and 72%, inclusive, preferably between 63 and 69%, inclusive, more preferably between 65 and 67% inclusive, even more preferably substantially equal to 66%.

Advantageously, so that the milling on the elongate element prepares the best inner groove, the ratio between the larger and smaller radiuses and the ratio between the length of the access opening to the inner groove and the width of the inner groove are mutually in a proportion of between 1.30 and 2.00, inclusive, preferably between 1.40 and 1.90, inclusive, more preferably between 1.50 and 1.80, inclusive, even more preferably between 1.60 and 1.70, inclusive.

Another aspect relates to the process for making the component for shelving, shelves, bookcases, stairs and similar furnishing elements.

The process comprises the following steps:
extruding the metal crosspieces provided with snap fitting means for their reciprocal connection and the elongate element (or the elongate elements provided);
milling each elongate element along the longitudinal direction, which is of extension of the elongate element, in such a way as to form the inner groove for housing the induction lighting means and so that the inner groove has a substantially elliptical curvilinear profile shaped in such a way as to hide the light source of the lighting means from direct contact with the eye of the user;
making ducts for the passage of the electrification cables on the metal crosspieces, in such a way as to allow the mutual communication between each of the inner grooves with the corresponding ducts;
connecting the metal crosspieces using the snap fitting means so as to form a frame;
positioning the elongate element and the reinforcement plate, one adjacent to the other, inside the perimeter defined by the frame; the elongate element houses the lighting means in its inner groove and the reinforcement plate is of the type with the honeycomb structure described above: this positioning is performed in such a way as to form an intermediate layer lying in the plane of extension of the component;
passing the cables for electrifying the lighting means along the ducts in such a way as to be able to connect them to the lighting means;
making, by removing material, a window on a first of the two laminar elements, in such a way that the window is defined at the inner groove so that the light emitted by the lighting means is not stopped by the thickness of the first element; and
gluing the laminar elements, both the first and the second, to opposite faces of the intermediate layer, in such a way as to make the component.

Preferably, during the making of the window on the first element, the holes necessary for the passage of the electrical cables are made, again by removal of material.

Advantageously, the milling of each elongate element comprises the forming of inner grooves having a curved profile which is made by placing in succession at least three circular arcs of different radius and in increasing sequence with respect to each other (a circumference of smaller radius, one of intermediate radius and a third of larger radius), so as to allow the head of the machining cutter to enter into the thickness to be removed in the most suitable manner.

Preferably, the larger of the three radiuses is greater than the intermediate radius by a percentage range of between 33 and 43%. inclusive, preferably between 35 and 41%, inclusive, more preferably between 37 and 39% inclusive, even more preferably substantially equal to 38%.

Similarly, the intermediate radius is in turn preferably larger than the smaller radius by a percentage range of between 60 and 72%, inclusive, preferably between 63 and 69%, inclusive, more preferably between 65 and 67% inclusive, even more preferably substantially equal to 66%.

Advantageously, so that the milling on the elongate element prepares the best inner groove, the ratio between the larger and smaller radiuses and the ratio between the length of the access opening to the inner groove and the width of the inner groove are mutually in a proportion of between 1.30 and 2.00, inclusive, preferably between 1.40 and 1.90, inclusive, more preferably between 1.50 and 1.80, inclusive, even more preferably between 1.60 and 1.70, inclusive.

### BRIEF DESCRIPTION OF THE DRAWINGS

Further features and advantages of the invention are more apparent from the description of a preferred, non-limiting embodiment of the component for shelving, shelves, bookcases, stairs and similar furnishing elements, illustrated by way of example and without limiting the scope of the invention, with the aid of the accompanying drawings, in which:

FIG. 1 is a perspective view from above of a component 1;

FIG. 2 is a perspective view from below of the component 1;

FIG. 3 is a perspective view of the component 1 with a first laminar element 2′ separated from the intermediate layer 3;

FIG. 4 is an exploded view of the component 1 with an enlargement for the snap fitting means (32 and 33);

FIG. 5 is a cross-section of the component 1 in a plane substantially parallel to the plane P;

FIG. 6 is a cross section through line VI-VI;

FIG. 7 is a cross section through line VII-VII;

FIG. 7a shows an enlargement of the cross-section 7.

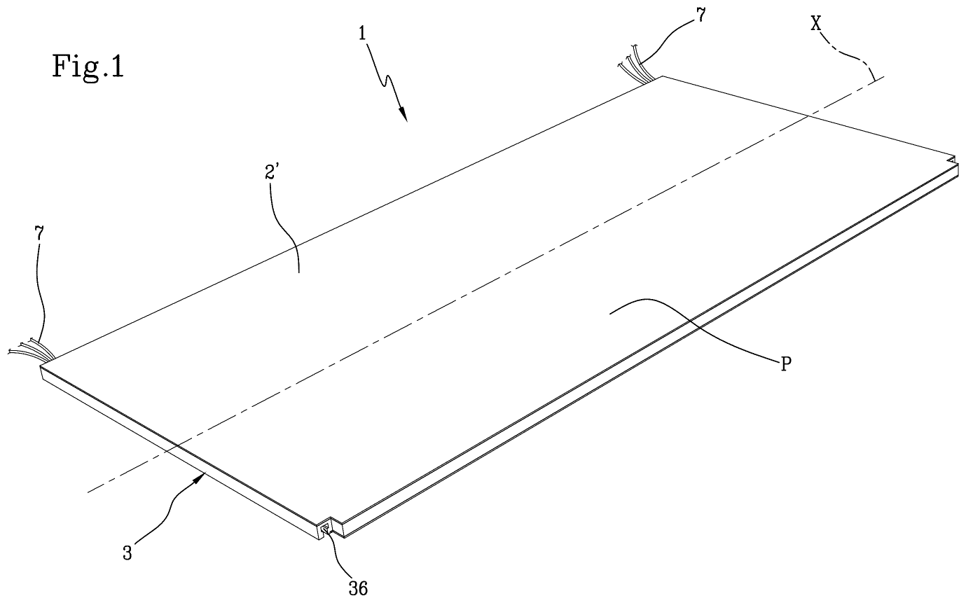

### DETAILED DESCRIPTION OF THE ACTUATION OF INVENTION

The above-mentioned drawings show a preferred embodiment of a component for shelving, shelves, bookcases, stairs and similar furnishing elements, according to the invention, which is denoted in its entirety by the numeral 1 and which comprises a first 2′ and a second laminar element 2″, substantially parallel with each other, which define, with the intermediate layer 3 interposed between them (and which they cover), the plane P of extension of the component 1. The intermediate layer 3 has a frame consisting of metal crosspieces 3′ and 3″ removably connected to each other by snap fitting means. The crosspieces 3′ and 3″, made of aluminium, comprise a pair of vertical rods 3′ and a pair of horizontal rods 3″ substantially normal to each other. The frame defines a perimeter, inside of which are positioned two elongate elements 4, also made of aluminium, for housing LED strips 6 inside inner grooves 41 which extend along the longitudinal direction X in the elements 4.

The crosspieces 3′ and 3″ in the same way as the elongate elements 4 have grooves or knurls, of per se known type, to facilitate the gluing of the laminar elements 2′ and 2″.

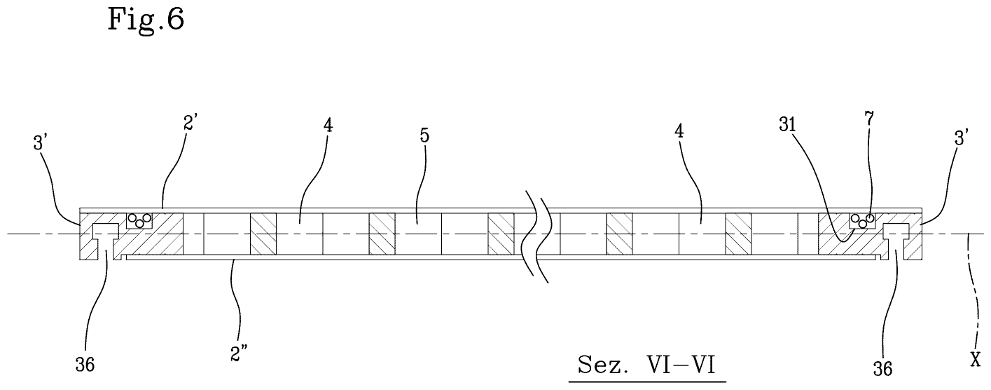

The vertical rods 3′ have slots 36 (FIG. 6) designed to engage with suitable guides (not illustrated) formed on external panels for the sliding of the component 1.

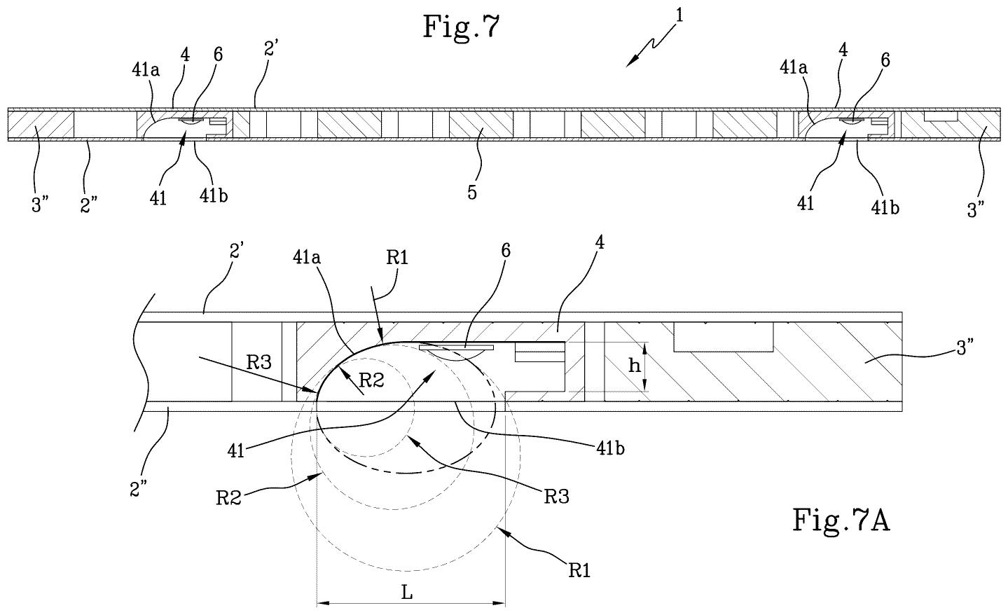

With reference to FIGS. 7 and 7a, the grooves 41 have a curvilinear, substantially elliptical profile 41a, shaped in such a way that the light source of the LEDs 6 is hidden from direct contact with the eye of the user.

The curvilinear profile 41a is formed by placing in succession three circular arcs C1, C2 and C3 of different radiuses R1 (larger radius), R2 (intermediate radius) and R3 (smaller radius), wherein R1>R2>R3.

Preferably, R1 is approximately 38% larger than R2.

Similarly, R2 is, in turn, greater than R3 by about 66%.

In practice:

$$R 1 = 11.5 mm ;$$

$$R 2 = 8.3 mm ;$$

$$R 3 = 5 mm .$$

The ratio between the radiuses R3 and R1 and the ratio between the length L of the access opening 41b to the inner groove 41 and the width h of the inner groove 41 are in a reciprocal proportion of between 1.60 and 1.70, inclusive.

More specifically, this ratio is approximately 1.65.

In effect, if—as stated—R is the ratio between the radiuses R3 and R1 and K is the ratio between the width (or height) h and the length L of the groove 41, then in the case in question:

$$R = R 3 / R 1 = 5 mm / 11.5 mm = 0.435$$

$$K = h / L = 5 mm / 19 mm = 0.263$$

$$R / K = 1.65 4 .$$

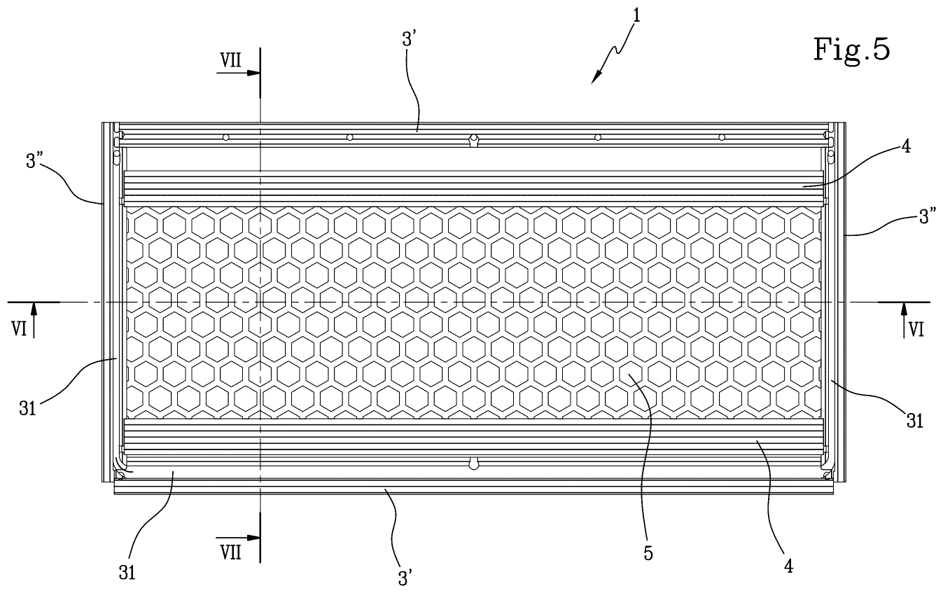

The LEDs 6 are electrified by electrical cables 7 which pass through ducts 31 formed on the vertical rods 3′ and connect with the LEDs 6 by means of openings 34′ for communication with the corresponding inner groove 41 (FIG. 5).

According to a variant embodiment, the ducts 31 may also be made on the horizontal rods 3″, obviously provided with openings 34″.

The cables 7 are electrified by means of pressure-fitted electrical contacts, in such a way that the LEDs 6 can be activated by contact with a suitable switch positioned on an outer wall substantially normal relative to the plane P of extension of the component 1.

Between the two elongate elements 4, inside the perimeter defined by the frame composed of the crosspieces 3′ and 3″ there is a reinforcement plate 5, adjacent to the elements 4. The plate 5 has a structure consisting of a tessellation of the space of the honeycomb type, honeycomb-shaped.

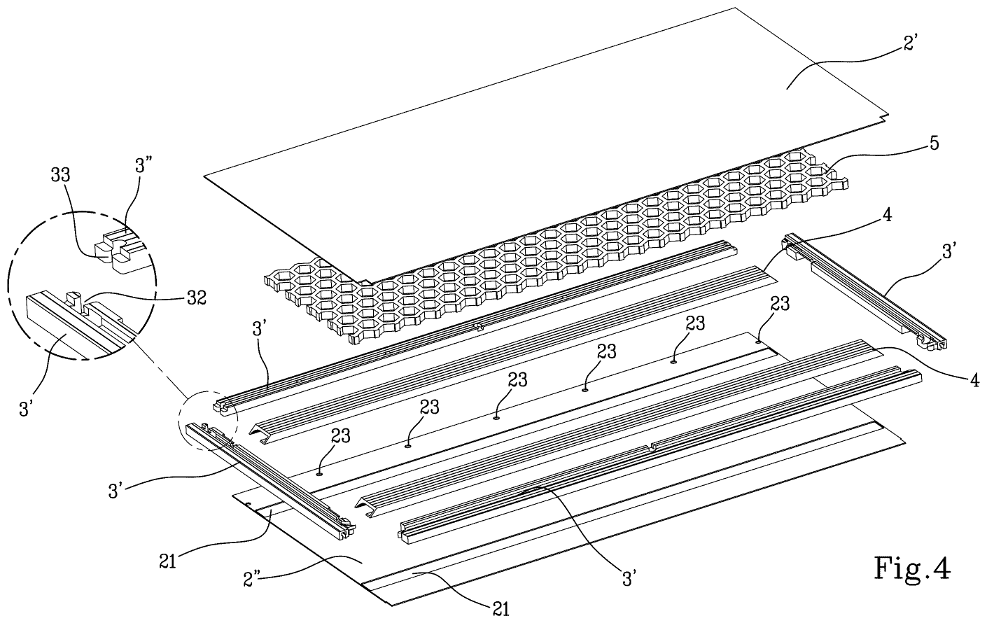

According to the embodiment described here, the snap fitting means comprise two male elements 32 protruding from each of the vertical rods 3′ for engaging with the respective female element 33 defined at the respective horizontal rod 3″. Each horizontal rod 3″ will also have two female elements 33 (FIG. 4).

According to a variant embodiment comprising only one elongate element, the vertical rods 3′ will obviously each be equipped with a single male element 32.

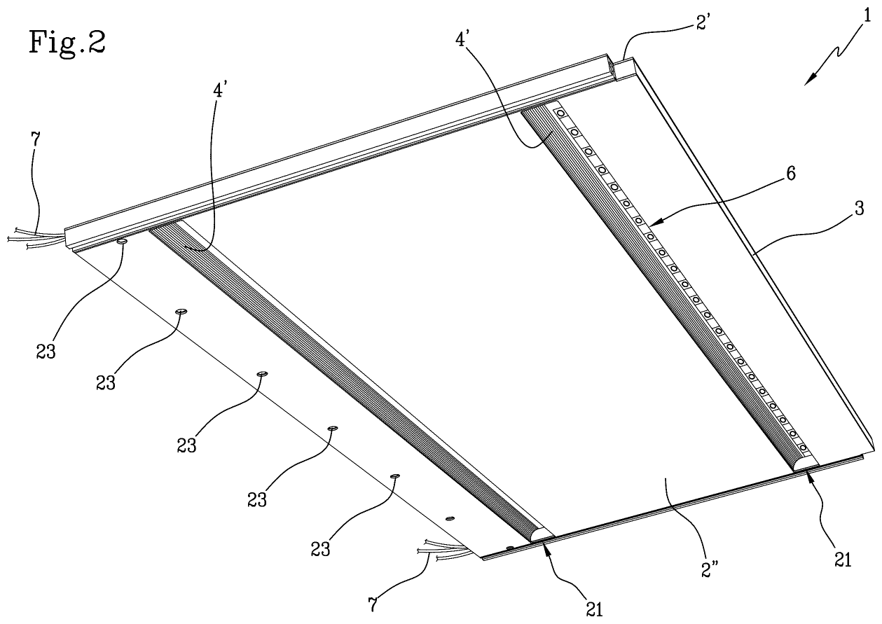

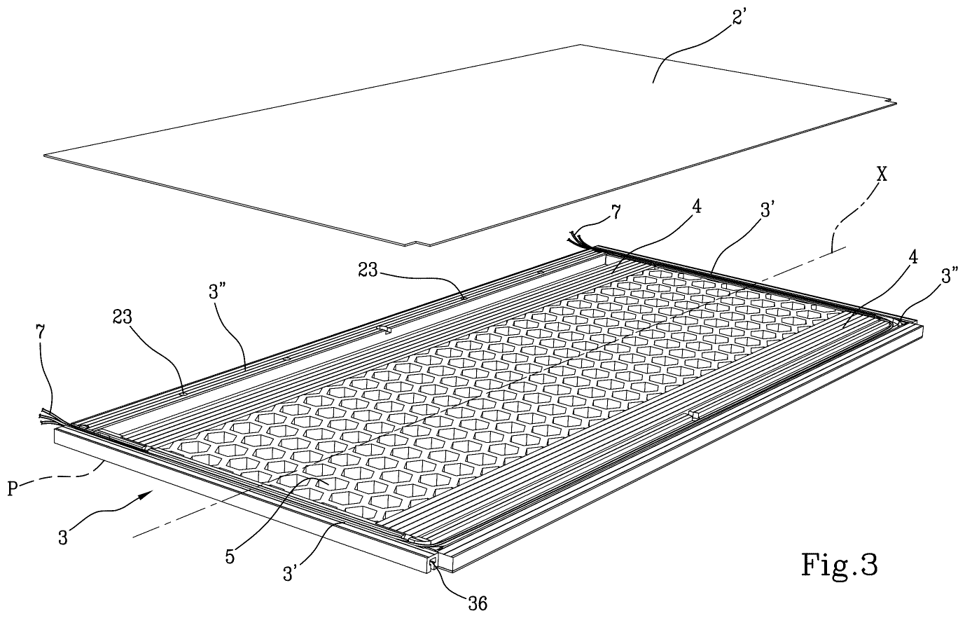

Lastly, the second laminar element 2″, which is glued on the intermediate layer has the appropriate windows 21 formed at the grooves 41, so that the light emitted by the LEDs 6 is not stopped by the thickness of the second element 2″. Moreover, the element 2″ also comprises the holes 23 necessary for the passage of other electrical cables 7 (FIG. 2).

From the above description it may be seen how the invention achieves the preset purpose and aims and in particular the fact that a component is made for shelving, shelves, bookcases, stairs and similar furnishing elements, for example a shelf, a crosspiece, an upright or a sash which is light and robust.

More specifically, the aluminium structure makes it possible to reach an ultra-thin thickness inside of which it is possible to house a luminous groove without the structure yielding in terms of mechanical strength.

An advantage of the invention is that this component is a module structured in such a way as to be able to satisfy, with its mechanical characteristics of strength and lightness, the requirements of an entire range of objects designed for the construction of furnishings in general: unlike standard furnishing components made of wood which, in order to guarantee comparable strength, require greater thicknesses and, consequently, are very heavy, proportional to the length of the shelf body.

Another advantage of the invention is due to the fact that, even in the case of a “long” components, intermediate supports are not necessary to guarantee the support of the “sag” of the weight of the component at the centre of the body: such elements are absolutely necessary on wooden furniture if they certainly exceed a metre and a half in length.

Another advantage of this technical feature is that the lightweight and resistant structure allows certain limits to be overcome in the requirements and the mechanical processing applied previously, such as, for example, the limit in the deep holes for the passage of cables.

Another advantage of this component is that the use of the raw material, that is to say, aluminium, is rationalised, with a consequent and significant reduction in weight (from 30% to 70% less), but also a considerable saving in economic terms considering the increasingly high cost of raw materials.

Another advantage of the invention is that inside an extremely thin thickness, of just 10 mm compared with 19 mm of wooden structures, there is a complete and integrated lighting system.

Another advantage of the invention is that, thanks to this solidity, together with the lightness of the structure, the production of cabinets, kitchens, display units, bookcases, display cabinets and modular structures of various types is guaranteed. Moreover, inside each single component it is possible to house a frame for engaging hinges, guides or other mechanisms designed for the rotation and/or translation of the elements.

Lastly, the use of means which are easily available on the market and the use of common materials makes the device economically competitive.

The invention can be modified and adapted in several ways without thereby departing from the scope of the inventive concept.

Moreover, all the details of the invention may be substituted by other technically equivalent elements.

In practice, the materials used, as well as the dimensions, may be of any type, depending on requirements, provided that they are consistent with their production purposes.

1. A component for shelving, shelves, bookcases, stairs and similar furnishing elements comprising:
at least two laminar elements substantially parallel to each other and defining a plane (P) of extension of the component;
said at least two laminar elements covering an intermediate layer, interposed between them, substantially coplanar to said plane (P);
said intermediate layer having a frame consisting of metal crosspieces designed to be connected to each other by snap fitting means, for supporting at least one elongate element, made of metal material, extending along a longitudinal direction (X) substantially normal relative to said plane (P) and for housing induction lighting means and positioned inside the perimeter defined by said frame;
said metal crosspieces having ducts for the passage of cables for electrifying said lighting means.

2. The component according to claim 1, wherein a reinforcement plate positioned inside the perimeter defined by said frame, adjacent to said at least one elongate element and having a structure consisting of a tessellation of the space of a honeycomb type, preferably shaped like a honeycomb.

3. The component according to claim 1, wherein said at least one elongate element comprises an inner groove for said lighting means;
said inner groove having a curvilinear substantially elliptical profile shaped in such a way that the light source of the lighting means is hidden from direct contact with the eye of the user.

4. The component according to claim 1, wherein said curvilinear profile consists of the succession of at least three circular arcs of different radius, in such a way that the ratio between the radiuses of the smaller and larger circumference and the ratio between the width (h) of said inner groove and the length of the access opening of said inner groove, are mutually in a proportion of between 1.30 and 2.00, inclusive, preferably between 1.40 and 1.90, inclusive, more preferably between 1.50 and 1.80, inclusive, even more preferably between 1.60 and 1.70, inclusive.

5. The component according to claim 1, wherein said metal crosspieces, constituting the frame, comprise at least a pair of vertical rods and a pair of horizontal rods which are mutually normal.

6. The component according to claim 1, wherein the snap fitting means comprise at least one male element protruding from at least one of said vertical rods and designed to be engaged with a female element defined at the respective one of said horizontal rods.

7. The component according to claim 3, wherein said ducts are defined along the direction of extension of said metal crosspieces and have, at said at least one elongate element, an opening for communication with said inner groove.

8. A process for making a component for shelving, shelves, bookcases, stairs and similar furnishing elements comprising the steps which consist of:
extruding metal crosspieces having snap fitting means for their reciprocal connection and at least one elongate element made of metal material;
milling said at least one elongate element along a longitudinal direction of extension of said at least one elongate element, in such a way as to form an inner groove designed to house induction lighting means and so that said inner groove has a substantially elliptical curvilinear profile shaped in such a way as to hide the light source of said lighting means from direct contact with the eye of the user;
making ducts for the passage of cables for electrifying said lighting means on said metal crosspieces, in such a way as to allow the mutual communication between each of said inner grooves with the corresponding said conduits;
connecting said metal crosspieces using said snap fitting means to form a frame defining a perimeter;
positioning, inside said perimeter, at least one elongate element and a reinforcement plate, one adjacent to the other in such a way as to form an intermediate layer defining a plane of extension of the component;
said at least one elongate element housing said lighting means in said inner groove and said reinforcing plate having a structure consisting of a tessellation of the space of the honeycomb type, preferably honeycomb-shaped;
said intermediate layer interposing at least two laminar elements substantially parallel to each other;
passing said cables in said ducts in such a way as to be able to connect them to said lighting means;
making, by removing material, a window on a first element of said at least two laminar elements;
said window being defined at said inner groove, in such a way that the light emitted by said lighting means is not stopped by the thickness of said first element (2′); and
gluing said laminar elements to opposite faces of said intermediate layer in such a way as to make the component.

9. The process according to claim 8, wherein the step of milling said at least one elongate element comprises making said inner groove in such a way that it has a curved profile made by placing in succession at least three circular arcs of different radiuses, a larger radius, an intermediate radius and a smaller radius, and in increasing sequence with each other along the milling line.

10. The process according to claim 9, wherein said larger radius is greater than said intermediate radius by a percentage range of between 33% and 43%, inclusive, preferably between 35 and 41%, inclusive, more preferably between 37 and 39% inclusive, even more preferably substantially equal to 38% and said intermediate radius is, in turn, greater than said smaller radius by a percentage range of between 60 and 72%, inclusive, preferably between 63 and 69%, inclusive, more preferably between 65 and 67% inclusive, even more preferably substantially equal to 66%.
